(19) United States
(12) Patent Application Publication
(10) Pub. No.: US 2017/0194821 A1
(43) Pub. Date: Jul. 6, 2017

(54) STATOR STRUCTURE OF BRUSHLESS DUST COLLECTOR MOTOR AND FORMING METHOD THEREFOR

(71) Applicant: KINGCLEAN ELECTRIC CO., LTD., Suzhou, Jiangsu (CN)

(72) Inventor: Zugen NI, Suzhou, Jiangsu (CN)

(21) Appl. No.: 15/314,289

(22) PCT Filed: Feb. 11, 2015
(86) PCT No.: PCT/CN2015/072750

§ 371 Date: Nov. 28, 2016

(30) Foreign Application Priority Data
May 28, 2014 (CN) 201410231279.4

(51) Int. Cl. H02K 1/14; H02K 15/02; H02K 15/095; H02K 3/18

(52) U.S. Cl. CPC H02K 1/143; H02K 3/18; H02K 15/022; H02K 15/095

(57) ABSTRACT

A stator structure of a brushless dust collector motor. The stator structure is a separate-type structure, and comprises a left iron core and a right iron core that are detachably connected. The upper end of the left iron core and the upper end of the right iron core extend to form pole shoes, the front edges of the pole shoes are deviated leftwards with the centers of the inner circles of the pole shoes as the benchmarks, chamfers of 30 to 60 degrees are formed, and the rear edges of the pole shoes are provided with fillets. Pole shoe deflection angles need to be arranged according to the structure of the stator iron cores, and the use requirement for the rotating speed of a brushless motor is met. Because the stator iron cores are designed into the separate-type structure, winding processing can be respectively conducted on the left iron core and the right iron core, and afterwards the two iron cores are fixed, so the stator winding process is simplified, the production efficiency is improved, and a paint layer is prevented from being damaged. The left iron core and the right iron core can be connected and fixed by adopting an embedding mode, so the accuracy of the connecting position of the two iron cores is effectively ensured, and the operation stability and reliability of the motor are improved. The stator structure is applicable in high-speed brushless motors and is advantageous in having a high rotating speed, high performance and a small size, and being convenient to carry and energy-saving and the like.

This application claims the benefit of priority to Chinese patent application No. 201410231279.4, titled “STATOR STRUCTURE OF MOTOR OF BRUSHLESS VACUUM CLEANER AND FORMING METHOD THEREFOR”, filed with the Chinese State Intellectual Property Office on May 28, 2014, the entire disclosure of which is incorporated herein by reference.

### FIELD

The present application relates to the technical field of producing and manufacturing motors of vacuum cleaners, and particularly relates to a stator structure of a motor of a brushless vacuum cleaner and a method for forming the stator structure.

### BACKGROUND

A vacuum cleaner is an electric cleaning apparatus which utilizes a motor to drive blades to rotate at a high speed, to generate a negative air pressure in a sealed housing, and thereby suctioning dusts into a dust bag. Vacuum cleaners can be generally divided into vertical type vacuum cleaners, horizontal type vacuum cleaners, and portable type vacuum cleaners and the like according to the structure.

A vacuum cleaner motor is a core component of a vacuum cleaner, and generally consists of two parts, including a motor part and a fan part. Since the vacuum cleaner motor is required to operate at a high rotational speed, generally at 20000-30000 rotations per minute, conventional vacuum cleaner motors are generally series excited motors and small direct current motors. The series excited motors and the small direct current motors all belong to brush motors, and their rotational speeds range from 20000 rotations per minute to 40000 rotations per minute. Though their rotational speeds can meet the requirement for the vacuum cleaner motor, the brush motors have large volumes and low performances, and are not portable and has a limited application scope.

With the development of the electric industry, vacuum cleaner motors are also developed in a trend of high performance, high efficiency and minimization. Brushless direct current motors have been more and more widely used in the industry due to their advantages, such as small volume, low noise, high efficiency, high reliability and strong adaptability.

For meeting the requirements of brushless motors, generally, the volume of an iron core should be reduced as much as possible. A conventional iron core has an integral structure, and coils are wound on left and right sides of the iron core, and the wire winding process is complicated. Since an upper end of the iron core is provided with a pole shoe, when winding wires, the enameled wire is likely to hit the pole shoe which may cause damages to an enameled coating, therefore adversely affecting the performance of the stator. In the case that the iron core has a small volume, the wire winding process is more difficult.

Therefore, in view of the above issues, it is necessary to provide a new stator iron core structure, which is applicable to a brushless vacuum cleaner motor, to allow the motor to have advantages such as having high rotational speed, high performance, a small volume, being portable and energy-saving, and also to simplify the wire winding process of the stator, improve the production efficiency, and avoid damages to the enameled coating.

### SUMMARY

In view of this, a stator structure of a brushless vacuum cleaner motor is provided according to the present application, to allow the motor to have advantages such as having high rotational speed, high performance, a small volume, being portable and energy-saving. A stator iron core is designed as a separated structure, wire winding process can be performed respectively on the iron cores at two sides, and then the two iron cores are fixed, thereby simplifying the winding process of the stator, improving the production efficiency, and avoiding damages to an enameled coating.

A stator structure of a brushless vacuum cleaner motor is provided according to an object of the present application, the stator structure has a separated structure, and includes a left iron core and a right iron core detachably connected to each other, each of the left iron core and the right iron core has a chamfer angle on one edge, and the chamfer angle ranges from 30 degrees to 60 degrees, and the left iron core and the right iron core both wound with a coil are fixed by welding.

Preferably, an upper end of each of the left iron core and the right iron core extends to form a pole shoe, and a front edge of the pole shoe is deviated leftwards with a center of an inner circle of the pole shoe as a reference, to form the chamfer angle ranging from 30 degrees to 60 degrees, and a rear edge of the pole shoe is rounded to form a rounded corner.

Preferably, the front edge of the pole shoe is deviated leftwards with the center of the inner circle of the pole shoe as the reference, to form the chamfer angle of 45 degrees.

Preferably, a coil winding is wound around each of the left iron core and the right iron core, and the left iron core and the right iron core both wound with the coil winding are fixed and then combined to form the stator structure of the brushless vacuum cleaner motor.

Preferably, the left iron core and the right iron core are fixed in a locking manner, and connecting portions of the left iron core and the right iron core are provided with a locking groove or a locking member matching with each other.

Preferably, the locking groove and the locking member each has a rectangular, dovetail-shaped or U-shaped cross section.

Preferably, the connecting portions of the left iron core and the right iron core each extends outwards to form a fixing component, and fixing components of the left iron core and the right iron core are fixed by welding.

Preferably, the fixing components are respectively protrusions integrally formed on bottoms of the left iron core and the right iron core.

A method for forming a stator structure of a brushless vacuum cleaner motor includes the following steps:

(1) machining and forming a left iron core and a right iron core respectively, and integrally forming fixing components for welding on bottoms of the left iron core and the right iron core;

(2) chamfering a front edge of a pole shoe of each of the left iron core and the right iron core by an angle ranging from 30 degrees to 60 degrees according to a use requirement, to form a leftward deviated chamfer angle, and rounding a rear edge of the pole shoe of each of the left iron core and the right iron core to form a rounded corner;

(3) machining and forming a locking groove and a locking member matching with each other in connecting surfaces at the bottoms of the left iron core and the right iron core respectively;

(4) winding coil windings respectively around the left iron core and the right iron core;

(5) embedding the locking member into the locking groove, to fixedly connect the left iron core and the right iron core, to ensure the left iron core and the right iron core to have a fixed relative position; and

(6) performing welding at the fixing components, to finally combine the left iron core and the right iron core to form the stator structure of the brushless vacuum cleaner motor.

Compared with the conventional technology, the stator structure of the brushless vacuum cleaner motor according to the present application has the following advantages.

1. The stator structure is applicable to a high speed brushless motor, thus allowing the motor to have advantages such as high rotational speed, high performance, small volume, being portable, energy saving and etc.

2. The stator iron core is designed as a separated structure, wire winding process can be performed respectively on the two iron cores, and then the two iron cores are fixed, thereby simplifying the wire winding process of the stator, improving the production efficiency, and avoiding damages to an enameled coating.

3. The pole shoe chamfer angles can be set according to structural requirements of the stator iron core, thus meeting the usage requirement of the rotational speed of the brushless motor.

4. The two iron cores at the two sides are fixedly connected in an embedding manner, thus effectively ensuring the accuracy of the connecting positions of the two iron cores, and improving the stability and reliability of the operation of the motor.

### BRIEF DESCRIPTION OF THE DRAWINGS

For more clearly illustrating embodiments of the present application or technical solutions in the conventional technology, drawings referred to describe the embodiments or the conventional technology will be briefly described hereinafter. Apparently, the drawings in the following description are only some examples of the present application, and for the person skilled in the art, other drawings may be obtained based on these drawings without any creative efforts.

FIG. 1 is a schematic view showing a stator structure of a brushless vacuum cleaner motor according to the present application in a separated state.

FIG. 2 is a schematic view showing the stator structure of the brushless vacuum cleaner motor according to the present application in a combined state.

Names of components denoted by reference numerals or letters in the drawings:

1 left iron core, 2 right iron core,

3 front edge of pole shoe, 4 rear edge of pole shoe,

5 coil winding, 6 locking groove,

7 locking member, and 8 fixing component.

### DETAILED DESCRIPTION

Conventional vacuum cleaner motors are generally brush motors, and the brush motors have large volumes and low performances, are not portable and have a limited application scope. Brushless motors have been more and more widely used in the industry due to advantages, such as small volume, low noise, high efficiency, high reliability and strong adaptability. For meeting the requirements of brushless motors, generally, the volume of an iron core should be reduced as much as possible. A conventional iron core has an integral structure, and coils are wound on left and right sides of the iron core, the wire winding process is complicated. Since an upper end of the iron core is provided with a pole shoe, when winding wires, the enameled wire is likely to hit the pole shoe which may cause damages to an enameled coating, therefore adversely affecting the performance of the stator. In the case that the iron core has a small volume, the wire winding process is more difficult.

In view of the deficiencies in the conventional technology, a stator structure of a brushless vacuum cleaner motor is provided according to the present application, to allow the motor to have advantages such as having high rotational speed, high performance, a small volume, being portable and energy-saving. A stator iron core is designed as a separated structure, wire winding process can be performed respectively on the iron cores at two sides, and then the two iron cores are fixed, thereby simplifying the winding process of the stator, improving the production efficiency, and avoiding damages to an enameled coating.

The technical solutions of the present application will be clearly and completely described hereinafter in conjunction with embodiments. Apparently, the embodiments described are only some examples of the present application, and not all implementations. Other embodiments obtained by the person skilled in the art based on the embodiments of the present application without any creative efforts all fall into the scope of the present application.

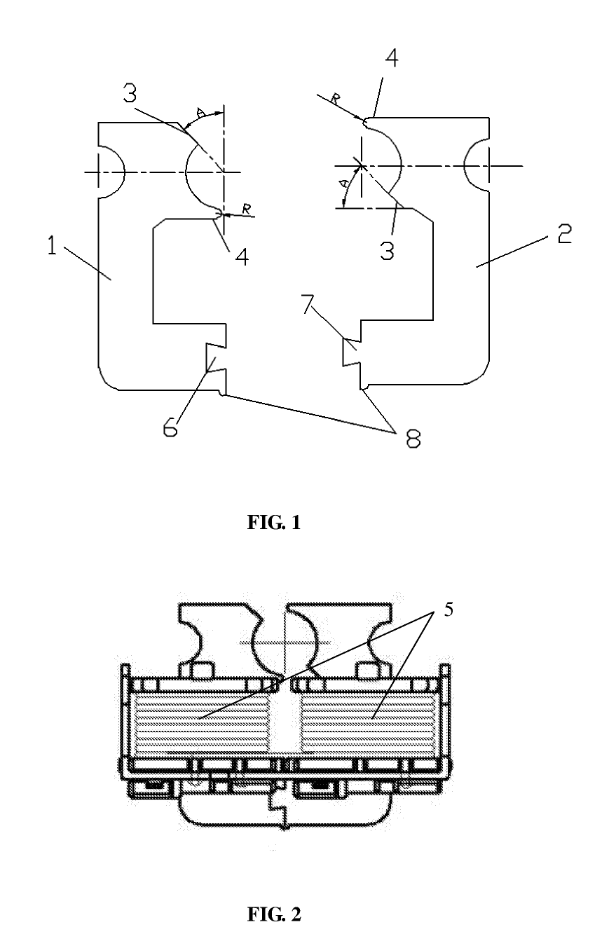

Reference is made to FIGS. 1 and 2, as illustrated, a stator structure of a brushless vacuum cleaner motor is provided, and has a separated structure. The stator structure includes a left iron core 1 and a right iron core 2 which are detachably connected. The left iron core and the right iron core each have a chamfer angle on one edge, and the chamfer angle ranges from 30 degrees to 60 degrees. The left iron core 1 wound with a coil and the right iron core 2 wound with a coil are fixed by welding. A coil winding 5 is wound around each of the left iron core 1 and the right iron core 2, and the left iron core and the right iron core both wound with the coil winding 5 are fixed and then combined to form the stator structure of the brushless vacuum cleaner motor. With the iron core having the separated structure, the left iron core and the right iron core can be fixed after coils are wound around the left iron core and the right iron core, thus simplifying the wire winding process, improving the production efficiency, and also avoiding damages to the surface coating of the enameled wire.

An upper end of each of the left iron core 1 and the right iron core 2 extends to form a pole shoe, and the thickness of a front edge of the pole shoe is less than the thickness of a rear edge of the pole shoe. A front edge 3 of the pole shoe is deviated leftwards with the center of an inner circle of the pole shoe as a reference, to form a chamfer angle ranging from 30 degrees to 60 degrees (indicated as A in FIG. 1). A rear edge 4 of the pole shoe is rounded to from a rounded corner R. The normal operation of the motor can be ensured by providing the pole shoe chamfer angle ranging from 30 degrees to 60 degrees.

The front edge of the pole shoe is deviated leftwards with the center of the inner circle of the pole shoe as a reference, to form a chamfer angle of 45 degrees. In the case that the pole shoe chamfer angle is 45 degrees, the motor has a good performance and a high operation speed, and the start and operation of the motor are facilitated, and further the arrangement of other components inside the motor, such as a Hall element, is facilitated. In addition, the chamfer angle may also be 35 degrees, 40 degrees, 50 degrees, 55 degrees and etc., the specific angle may be determined according to use requirements, which is not limited here.

The left iron core 1 and the right iron core 2 are fixed in a locking manner. Connecting portions of the left iron core and the right iron core are provided with a locking groove 6 or a locking member 7 matching with each other. With the fixing manner of locking and embedding, it can facilitate fixing the two iron cores to each other, and ensuring the accuracy of the connecting position, and avoiding a connection error of the iron cores and preventing the normal operation of the motor from being adversely affected, and improving stability and reliability of the operation of the motor.

Each of the locking groove 6 and the locking member 7 has a rectangular, dovetail-shaped, or U-shaped cross section, or the like. In the case of employing the dovetail-shaped cross section, the locking member may be inserted into the locking groove from one side of the locking groove, to achieve position limiting of the connecting portions of the iron cores in directions X and Z, to ensure the accuracy of the fixing positions. The dimension and number of the locking groove may be determined according to the size and thickness of the iron core. If multiple locking grooves and multiple locking members are employed, the multiple locking grooves and the multiple locking members are respectively evenly arranged in parallel with each other, thus increasing the connection stability.

The connecting portions of the left iron core and the right iron core each extends outwards to form a fixing component 8, and the fixing components at the two sides are fixed by welding. The fixing components are protrusions integrally formed at the bottoms of the left iron core and the right iron core respectively. In the state that the left and right iron cores are locked, the protrusions can be fixed by welding to improve the structural stability of the stator iron core of the separated structure.

A method for forming a stator structure of a brushless vacuum cleaner motor includes the following steps.

(1) A left iron core and a right iron core are machined and formed respectively, and a fixing component for welding is integrally formed on a bottom of each of the left iron core and the right iron core.

(2) A front edge of a pole shoe of each of the left iron core and the right iron core is chamfered by an angle ranging from 30 degrees to 60 degrees according to a use requirement, to form a leftward deviated chamfer angle, and a rear edge of the pole shoe of each of the left iron core and the right iron core is rounded to form a rounded corner.

(3) A locking groove and a locking member matching with each other are respectively machined and formed in connecting surfaces at the bottoms of the left iron core and the right iron core.

(4) A coil winding is wound around each of the left iron core and the right iron core.

(5) The locking member is embedded into the locking groove to fixedly connect the left iron core and the right iron core, to ensure the left iron core and the right iron core to have a fixed relative position.

(6) Welding is performed at the fixing components to finally combine the left iron core and the right iron core to form the stator structure of the brushless vacuum cleaner motor.

A stator structure of a brushless vacuum cleaner motor is disclosed according to the present application, and the stator structure has a separated structure and includes a left iron core and a right iron core detachably connected. An upper end of each of the left iron core and the right iron core extends to form a pole shoe. A front edge of the pole shoe is deviated leftwards with the center of an inner circle of the pole shoe as a reference, to form a chamfer angle ranging from 30 degrees to 60 degrees, and a rear edge of the pole shoe is rounded to form a rounded corner. The pole shoe chamfer angles can be set according to structural requirements of the stator iron cores, thus meeting the usage requirement of the rotational speed of the brushless motor.

A coil winding is wound around each of the left iron core and the right iron core, and the left iron core and the right iron core both wound with the coil winding are fixed and then combined to form the stator structure of the brushless vacuum cleaner motor. The stator iron core is designed as a separated structure, wire winding process can be performed respectively on the two iron cores, and then the two iron cores are fixed, thereby simplifying the wire winding process of the stator, improving the production efficiency, and avoiding damages to an enameled coating.

The two iron cores at two sides are fixedly connected in an embedding manner, thus effectively ensuring the accuracy of the connecting positions of the two iron cores, and improving the stability and reliability of the operation of the motor.

The stator structure is applicable to a high speed brushless motor, thus allowing the motor to have advantages such as high rotational speed, high performance, small volume, being portable, energy saving and etc.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. A stator structure of a brushless vacuum cleaner motor, wherein the stator structure has a separated structure, and comprises a left iron core and a right iron core detachably connected to each other, each of the left iron core and the right iron core has a chamfer angle on one edge, and the chamfer angle ranges from 30 degrees to 60 degrees, and the left iron core and the right iron core both wound with a coil are fixed by welding.

2. The stator structure of the brushless vacuum cleaner motor according to claim 1, wherein an upper end of each of the left iron core and the right iron core extends to form a pole shoe, and a front edge of the pole shoe is deviated leftwards with a center of an inner circle of the pole shoe as a reference, to form the chamfer angle ranging from 30 degrees to 60 degrees, and a rear edge of the pole shoe is rounded to form a rounded corner.

3. The stator structure of the brushless vacuum cleaner motor according to claim 2, wherein the front edge of the pole shoe is deviated leftwards with the center of the inner circle of the pole shoe as the reference, to form the chamfer angle of 45 degrees.

4. The stator structure of the brushless vacuum cleaner motor according to claim 1, wherein a coil winding is wound around each of the left iron core and the right iron core, and the left iron core and the right iron core both wound with the coil winding are fixed and then combined to form the stator structure of the brushless vacuum cleaner motor.

5. The stator structure of the brushless vacuum cleaner motor according to claim 1, wherein the left iron core and the right iron core are fixed in a locking manner, and connecting portions of the left iron core and the right iron core are provided with a locking groove or a locking member matching with each other.

6. The stator structure of the brushless vacuum cleaner motor according to claim 5, wherein the locking groove and the locking member each has a rectangular, dovetail-shaped or U-shaped cross section.

7. The stator structure of the brushless vacuum cleaner motor according to claim 1, wherein the connecting portions of the left iron core and the right iron core each extends outwards to form a fixing component, and fixing components of the left iron core and the right iron core are fixed by welding.

8. The stator structure of the brushless vacuum cleaner motor according to claim 7, wherein the fixing components are respectively protrusions integrally formed on bottoms of the left iron core and the right iron core.

9. A method for forming a stator structure of a brushless vacuum cleaner motor comprising the following steps:
(1) machining and forming a left iron core and a right iron core respectively, and integrally forming fixing components for welding on bottoms of the left iron core and the right iron core;
(2) chamfering a front edge of a pole shoe of each of the left iron core and the right iron core by an angle ranging from 30 degrees to 60 degrees according to a use requirement, to form a leftward deviated chamfer angle, and rounding a rear edge of the pole shoe of each of the left iron core and the right iron core to form a rounded corner;
(3) machining and forming a locking groove and a locking member matching with each other in connecting surfaces at the bottoms of the left iron core and the right iron core respectively;
(4) winding coil windings respectively around the left iron core and the right iron core;
(5) embedding the locking member into the locking groove, to fixedly connect the left iron core and the right iron core, to ensure the left iron core and the right iron core to have a fixed relative position; and
(6) performing welding at the fixing components, to finally combine the left iron core and the right iron core to form the stator structure of the brushless vacuum cleaner motor.

10. The method according to claim 9, wherein the chamfer angle is 45 degrees.

11. The method according to claim 9, wherein the locking groove and the locking member each has a rectangular, dovetail-shaped or U-shaped cross section.

12. The method according to claim 9, wherein the fixing components are respectively protrusions integrally formed on bottoms of the left iron core and the right iron core.
